(19) United States
(12) Patent Application Publication
(10) Pub. No.: US 2006/0283720 A1
(43) Pub. Date: Dec. 21, 2006

(54) Method and kit for creating colored gels for nails

(76) Inventor: Deborah Minnella, Ottawa (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/156,549

(22) Filed: Jun. 21, 2005

(51) Int. Cl. B44D 3/04

(52) U.S. Cl. 206/1.8

(57) ABSTRACT

A kit for creating colored gels for nails includes capsules containing differently colored pigments, a color-selection chart and a color-mixing chart that provides instructions for mixing the differently colored pigments in a predetermined volume of UV-curable resin to create the desired gel color. The colored gel can be applied to fingernails, toenails or artificial nail extensions and is cured by exposure to UV light.

### CROSS-REFERENCE TO RELATED APPLICATIONS

This is the first application filed for the present invention.

### MICROFICHE APPENDIX

Not Applicable.

### TECHNICAL FIELD

The present invention relates generally to methods and products for coloring fingernails, toenails and artificial nail extensions and, in particular, to a method and kit for creating colored gels for nails.

### BACKGROUND OF THE INVENTION

The coloring of fingernails, toenails and artificial nail extensions using lacquer-type nail polish, acrylics and UV-cured gel resins is well known in the cosmetics industry.

Although nail coloring is quite ancient, modern nail polish is a lacquer that usually includes resinous materials such as ether, shellac, gum, and alkyd resins that are dissolved in a solvent such as alcohol which evaporates quickly when applied, leaving behind a hard, smooth adherent film on the nail.

In modern nail enhancement technology, curable plastics are now commonly used as nail finishes. Unlike nail polish, which is usually self-applied, curable plastics are typically applied by nail technicians or estheticians at beauty parlors or salons. The curable plastic nail finishes include acrylic compositions and ultraviolet cured polymers. Acrylic compositions are typically made using a two-part system of a liquid monomer and a powdered polymer that is mixed together and brushed onto nails where the monomer-polymer mixture cures and hardens on the nail in a few minutes without requiring a curing agent. Ultra-violet cured polymers on the other hand are an acrylic polymer in a gel-like state that requires curing under a UV lamp. Such nail finishes can be applied directly to natural fingernails or toenails, or alternatively can be applied to nail extensions bonded to fingernails.

Beauty parlors and nail salons typically offer a panoply of colors to suit a variety of tastes and fashions. These establishments are therefore required to stock a large number of colors. This tends to be a problem for such establishments, because it is expensive to stock a full palette of colors. It is not only expensive to purchase a complete palette of colors, it is also costly to replenish one's supply when popular colors are depleted, because they are generally only sold as a complete set and it is often impossible to buy only a few select replacement colors.

The prior art kits for creating polishes are known. For example, U.S. Pat. No. 5,778,901 (Abrahamian) entitled NAIL POLISH KIT FOR MIXING NAIL POLISH describes a personal nail polish kit that includes a plurality of dispensing bottles and tubes containing different colors of nail polish. The different colors can be mixed in different proportions, according to a coloring guide, to create many different colors and hues.

However, the Abrahamian method does not enable one to mix consistently reliable colors. Because the control of coloring is imprecise and the resulting colors tend to be inconsistent.

Another color-mixing method is disclosed in U.S. Pat. No. 6,192,892 (Resler) entitled SYSTEM AND METHOD FOR APPLYING COLOR TO A NAIL. Resler describes a palette having a plurality of receptacles for holding an applicator, a liquid solvent, and at least one solid color material. To apply the solid color material to a surface of a fingernail, the applicator is dipped into the solvent and then mixed with the desired solid color material to form a viscous color medium that can be applied to the nails without the need for suspension agents or thickening agents. However, as will be readily appreciated by those skilled in the art, the Resler method does not lend itself to precise reproducibility of desired colors.

Accordingly, it remains be highly desirable to provide an improved method and kit for creating a variety of colors and shades for colored gels for nails that achieve reliably predictable results.

### SUMMARY OF THE INVENTION

It is therefore an object of the present invention to provide an improved method and kit for accurately and repeatably creating colored nail gels.

The invention therefore provides a kit for creating colored nail gels, the kit comprising: a predetermined number of capsules respectively containing a predetermined volume of a colored pigment, the capsules being manipulatable to release their colored pigment into a predetermined volume of UV-curable polymer resin; and color-mixing instructions specifying a discrete combination of one or more of the capsules for creating a selected gel color by mixing the pigment in the one or more capsules with the predetermined volume of the UV curable polymer resin.

The invention further provides a method of creating colored gels for coloring nails, comprising: selecting a desired color from a color-selection chart; correlating the desired color with a recipe for creating the desired color, the recipe specifying at least one capsule containing a predetermined volume of a colored pigment for creating the desired color; and mixing the at least one capsule of the colored pigment in a predetermined volume of a UV-curable polymer resin.

The invention further provides a kit for creating gel colors for coloring nails, the kit comprising: at least one resin container containing a predetermined volume of a UV-curable polymer resin that will adhere to nails; a predetermined number of capsules respectively containing a predetermined volume of a colored pigment, the capsules being manipulatable to release their colored pigment into the container to permit the pigment to be mixed with the UV-curable polymer resin; and color-mixing instructions specifying a discrete combination of one or more of the capsules for creating a selected nail color by mixing the colored pigment in the one or more of the capsules with the predetermined volume of the UV-curable polymer resin.

The kits and method in accordance with the invention can be used to efficiently and simply create a wide variety of gel colors and shades for nails using a limited number of different pigments provided in pre-measured volumes contained in easily handled capsules. Therefore, since only a limited number of capsules are required to provide a large palette of colors for colored gels, substantial cost savings are realized. Furthermore, since the capsules dispense precise amounts of powdered pigment, color-mixing is controlled and exact, resulting in reliably reproducible colored gels.

### BRIEF DESCRIPTION OF THE DRAWINGS

Further features and advantages of the present invention will become apparent from the following detailed description, taken in combination with the appended drawings, in which:

FIG. 1 is a schematic representation of a kit for creating colored nail gels in accordance with an embodiment of the invention;

FIG. 2 is a flowchart showing a method of creating colors for UV-curable colored gels in accordance with an embodiment of the invention; and

FIG. 3 is a schematic diagram of a color-mixing chart for fifty different gel colors showing exemplary recipes for creating each of the different gel colors.

It should be noted that throughout the appended drawings, like features are identified by like reference numerals.

### DETAILED DESCRIPTION OF PREFERRED EMBODIMENTS

In general, the invention provides a kit and method for creating colored gels for coloring nails. The kit, in general, includes a plurality of capsules, each containing a predetermined volume of a colored pigment compatible with an ultraviolet light curable (UV-curable) polymer resin suitable for coloring nails polish. The capsules can be manipulated to release the powdered pigments into a container containing a predetermined volume of the UV-curable resin. The kit further includes a color-selection chart that displays a facsimile of each gel color that can be made using the kit. The kit also includes a color-mixing chart that provides recipes for mixing the differently colored pigments in the UV-curable polymer resin to create the desired gel color. The colored gel can be applied to fingernails, toenails or artificial nail extensions and is cured by exposure to UV light. The method in general includes selecting a desired nail color from a color-selection chart; and mixing contents of one or more of the capsules into a container containing the UV-curable polymer resin.

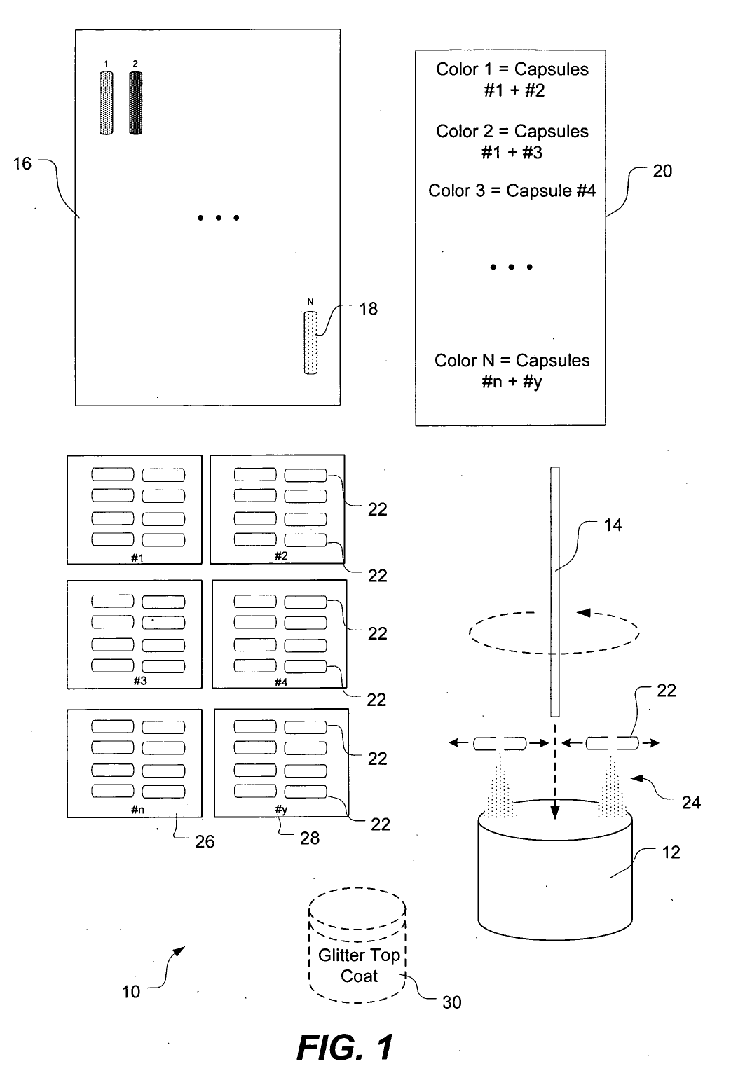

FIG. 1 is a schematic diagram of a kit 10 for creating colored gels in accordance with an embodiment of the invention. As is known in the art, colored gels are applied to nails in a gel-like state. The gel is then hardened, or cured, under a UV lamp to provide a very durable colored nail finish.

As shown in FIG. 1, the kit includes a color-selection chart 16 that includes a color facsimile of all gel colors that can be made using the kit. In one embodiment, each gel color is reproduced as a representation of colored nail extensions 18 arranged in rows and columns. The color-selection chart also includes a color indicia, for example a number 1, 2, . . . N to permit a nail technician or esthetician to correlate a desired gel color with a recipe for creating the desired gel color. Accordingly, the kit 10 further includes a color-mixing chart 20 of formulations or recipes for combining the colored pigment capsules with the UV-curable gel to create the desired gel color.

In one embodiment, the color-mixing chart 20 presents the recipes in a summarized, tabular format. Therefore, after a desired gel color is selected, the nail technician/esthetician simply locates the desired gel color's indicia in the color-mixing chart 20 in order to determine which capsules 22 are to be selected to create the desired gel color. As will be appreciated, color-mixing chart 20 can be integrated into the color-selection chart 16. The color-mixing chart and color-selection chart can be presented either in printed form (e.g. a color print, a brochure, laminated color printout, etc.) or, alternatively, in electronic form (e.g. viewable on a computer monitor).

The kit 10 includes a plurality of the capsules 22 Each capsule 22 contains a predetermined volume of colored pigment 24 in powdered form. The color-mixing chart 20 identifies a combination of one or more capsules 22 that, when the pigments 24 contained in the capsules 22 are mixed with a predetermined volume of the UV-curable polymer resin using a stir stick 14, for example, will create the desired gel color.

The capsules 22 are packed in packages 26, which may be bottles, vials, blister pacs, plastic pouches, or the like. Each package bears a capsule indicia, e.g. #1, #2, . . . #y. The capsule indicia is used in the color-mixing chart to indicate the capsule(s) to be selected for each recipe.

In one embodiment, the capsules are made of two frictionally engaged parts that can be manually pulled apart for dispensing the powdered pigments 24 into the mixing container 12, as shown in FIG. 1. In an alternative embodiment, the pigments are contained in a plastic or foil pouches that can be opened using any applicable technique. For convenience, any device for storing the pigments as units of a predetermined volume is hereinafter referred to as a capsule 22.

In one embodiment, the kit 10 may further include one or more containers 12, each containing a predetermined volume (½ ounce (14 g.) for example) of clear UV-curable polymer resin. The kit may further include one or more pre-mixed containers 30 of a “glitter top coat”, a composition well known in the art.

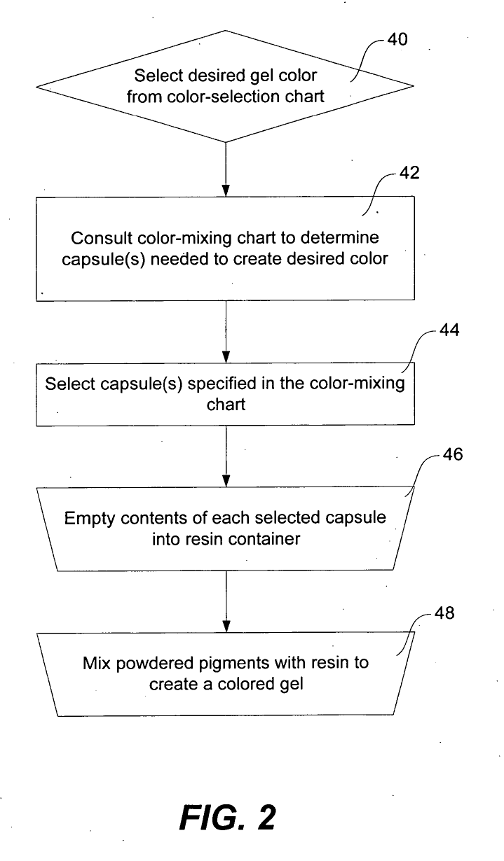

FIG. 2 is a flowchart showing a method of creating colored UV-curable gels in accordance with an embodiment of the invention. As shown in FIG. 2, the method includes an initial step 40 of selecting a desired nail color from the color-selection chart 16 as described above. After the color selection is made, the nail technician or esthetician consults (step 42) the color-mixing chart 20 to determine which capsule 22, or combination of capsules 22, is required to create the desired gel color. Subsequently, (step 44) the nail technician/esthetician selects the capsule(s) indicated on the color-mixing chart 20. Each capsule 22 is opened and the pigment it contains is emptied into a container 12 containing a predetermined volume of UV-curable polymer resin, for example, a one-half ounce container, specified by instructions contained in the kit. The colored pigment(s) are then mixed with the resin, (step 48) to create the colored gel. After mixing, the gel is ready for use.

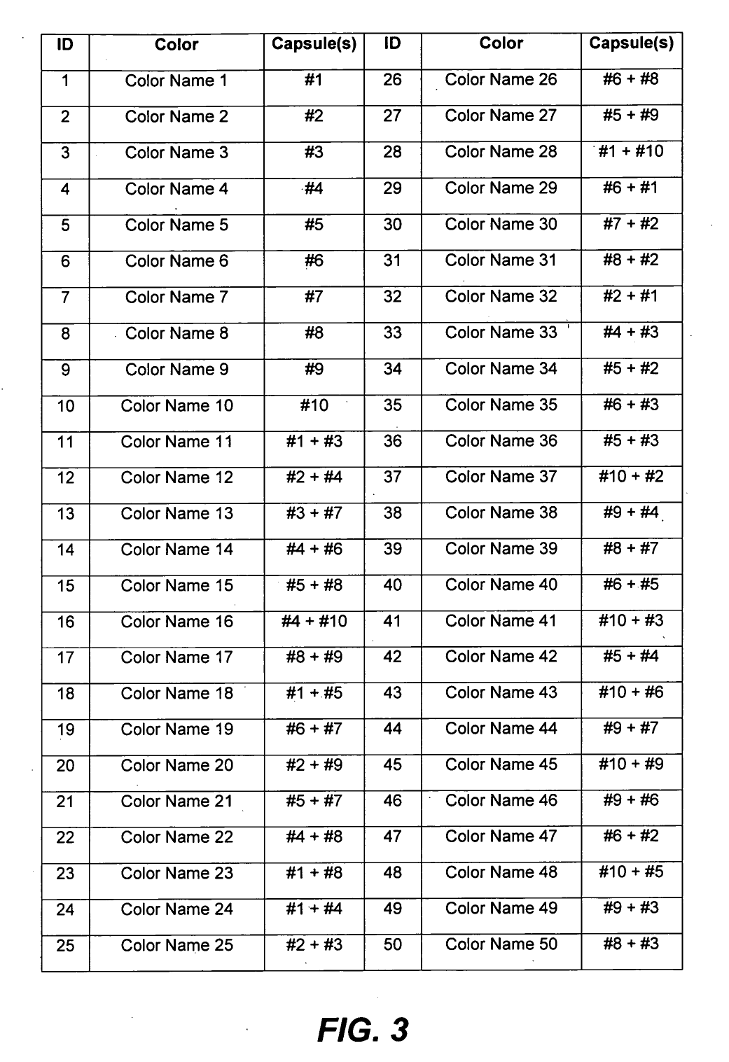

FIG. 3 is an exemplary color-mixing chart showing for the sake of illustration a palette of fifty different nail colors. In this example, the kit 10 includes ten capsules 22 containing differently colored pigments. These ten differently colored pigments, “base colors” or “fundamental colors”, can be used alone or in combination to create one of a variety of gel colors. It should be understood that, while this color-mixing chart presents colors made by mixing two differently colored pigments, it is also possible to create colors by combining three or more differently colored pigments. Therefore, it is to be emphasized that the color-mixing chart shown in FIG. 3 is merely illustrative of one embodiment of a kit 10 in which ten base colors are provided to create a palette of fifty color combinations. It is to be expressly understood that the number of base colors can be varied as well as the number of combinations. In a further embodiment, the kit provides differently sized capsules to provide different proportions of each base color to provide a larger panoply of shades and hues. It should also be understood that although each capsule 22 contains a predetermined volume of colored pigment, the volume of pigment in capsules 22 containing different colors may be different, depending on the characteristics of the respective pigments.

The kit and method therefore provides a cost-effective solution for beauty parlors and nail salons, enabling them to offer a broad selection of gel colors while only stocking a relatively small number of different base colors. Furthermore, as the capsules 22 are small and easily stored in the packages 26, the kit requires minimal storage space. Moreover, the color-selection display and color-mixing chart make the kit and method highly convenient for customers and nail technician alike. Because each capsule contains a precise volume of colored pigment, the kit and method reproduces colors with a high degree of fidelity, which permits a customer to continue use of a favorite color indefinitely because small, inexpensive batches can be reliably produced at reasonable cost over an extended period of time.

The embodiments of the invention described above are therefore intended to be exemplary only. The scope of the invention is intended to be limited solely by the scope of the appended claims.

I claim:

1. A kit for creating colored nail gels, the kit comprising:
a predetermined number of capsules respectively containing a predetermined volume of a colored pigment, the capsules being manipulatable to release their colored pigment into a predetermined volume of UV-curable polymer resin; and
color-mixing recipes specifying a discrete combination of one or more of the capsules for creating a selected gel color by mixing the pigment in the one or more capsules with the predetermined volume of the UV curable polymer resin.

2. The kit as claimed in claim 1 further comprising a color-selection chart for displaying a facsimile of each gel color that can be made using the kit.

3. The kit as claimed in claim 2 further comprising a color-mixing chart providing in a tabular format the color-mixing recipes, the color-mixing chart including a color indicia for correlating each facsimile in the color-selection chart with a corresponding color-mixing recipe in the color-mixing chart.

4. The kit as claimed in claim 1 wherein the color pigments are in powdered form.

5. A method of creating colored gels for coloring nails, comprising:
selecting a desired color from a color-selection chart;
correlating the desired color with a recipe for creating the desired color, the recipe specifying at least one capsule containing a predetermined volume of a colored pigment for creating the desired color; and
mixing the at least one capsule of the colored pigment in a predetermined volume of a UV-curable polymer resin.

6. The method as claimed in claim 5 wherein selecting the desired gel color comprises choosing the desired gel color from a color-selection chart-displaying all available gel colors that can be made using the kit.

7. The method as claimed in claim 6 wherein correlating comprises correlating a color indicia associated with the desired color on the color-selection chart with an indicia on a color-mixing chart to determine the at least one capsule of colored pigment required to be mixed with the predetermined volume of UV-curable polymer resin.

8. The method as claimed in claim 7 wherein the mixing comprises manipulating the at least one capsule to release a powdered pigment contained therein into the predetermined volume of UV-curable polymer resin.

9. A kit for creating gel colors for coloring nails, the kit comprising:
at least one resin container containing a predetermined volume of a UV-curable polymer resin that will adhere to nails;
a predetermined number of capsules respectively containing a predetermined volume of a colored pigment, the capsules being manipulatable to release their colored pigment into the container to permit the pigment to be mixed with the UV-curable polymer resin; and
color-mixing instructions specifying a discrete combination of one or more of the capsules for creating a selected nail color by mixing the colored pigment in the one or more of the capsules with the predetermined volume of the UV-curable polymer resin.

10. The kit as claimed in claim 9 comprising a plurality of the resin containers, each resin container containing one-half ounce of the UV-curable polymer resin.

11. The kit as claimed in claim 9 further comprising at least one top coat glitter gel container containing a predetermined volume of a pre-mixed top coat glitter for applying over a cured coat of the colored UV-curable polymer resin.

12. The kit as claimed in claim 9 further comprising a plurality of capsule packages containing the capsules, each capsule package containing a predetermined number of capsules of the colored pigment.

13. The kit as claimed in claim 12 wherein each capsule package is identified by a capsule indicia.

14. The kit as claimed in claim 13 wherein the capsule indicia comprises a number.

15. The kit as claimed in claim 9 wherein the color mixing instructions comprise a color-selection chart with associated recipes for mixing the gel colors shown on the color-selection chart.

16. The kit as claimed in claim 15 wherein the color-selection chart comprises a facsimile of each gel color and an associated color indicia.

17. The kit as claimed in claim 16 further comprising a color-mixing chart indexed by the color indicia, the color-mixing chart specifying the capsules to be mixed in the predetermined volume of the UV-curable resin.

18. The kit as claimed in claim 17 wherein the capsules of each colored pigment are packaged in a capsule package.

19. The kit as claimed in claim 18 wherein each capsule package is indexed by a capsule indicia.

20. The kit as claimed in claim 19 wherein the color-mixing chart indicates the capsules to be mixed in the UV-curable gel by specifying at least one capsule indicia.
